(19) United States
(12) Patent Application Publication
(10) Pub. No.: US 2005/0134717 A1
(43) Pub. Date: Jun. 23, 2005

(54) Portable device with camera

(75) Inventor: Atsushi Misawa, Saitama-ken (JP)

Correspondence Address: BIRCH STEWART KOLASCH & BIRCH, PO BOX 747, FALLS CHURCH, VA, 22040-0747, US

(73) Assignee: Fuji Photo Film Co., Ltd., Minami-Ashigara-shi (JP)

(21) Appl. No.: 10/992,338

(22) Filed: Nov. 19, 2004

(30) Foreign Application Priority Data
Nov. 26, 2003 (JP) 2003-395738

(51) Int. Cl. H04N 5/222

(52) U.S. Cl. 348/333.06

(57) ABSTRACT

A portable telephone with a camera which is capable of close-up photography. A first casing body is equipped with a control portion and a second casing body is equipped with a monitor. The first and second casing bodies are openably/closeably joined by a uni-axial hinge portion. The hinge portion enables rotation of the first casing body and second casing body by more than 180°. The first casing body and second casing body can be invertedly stood on a flat surface with the hinge portion oriented upward and the control portion and the monitor facing outward.

### CROSS-REFERENCE TO RELATED APPLICATION

This application claims priority under 35 USC 119 from Japanese Patent Application No. 2003-395738, the disclosure of which is incorporated by reference herein.

### BACKGROUND OF THE INVENTION

1. Field of the Invention

The present invention relates to a portable device incorporating a camera.

2. Description of the Related Art

Heretofore, portable telephones incorporating cameras, for close-up photography of subjects placed on tabletops, have been proposed.

For example, Japanese Patent Application Laid-Open (JP-A) No. 2000-358225 has disclosed a structure in which an antenna, which can be folded up, is abutted against a tabletop and sets a distance between a camera and a subject. In this structure, the camera is provided at a rear face of a monitor, a first casing is equipped with a keyboard, and a second casing is equipped with the monitor. The first casing and second casing are opened out to approximately 180° and a subject is photographed in this opened state. The monitor is oriented upward, so it is possible to take a close-up photograph while checking the subject with the monitor.

However, it is necessary for a camera operator to hold the portable telephone firmly, and the distance between the camera and the subject will vary greatly if the portable telephone is inclined even slightly relative to the subject. That is, there are concerns about steadiness at times of close-up photography.

Further, JP-A No. 2003-163824 has disclosed a structure in which two casings joined by a hinge are opened out to a certain angle of less than 180°. In this state, a hinge portion is oriented upward and the structure is invertedly stood on a tabletop, which sets a distance between a camera provided at the hinge portion and a subject. With this structure, steadiness at times of close-up photography is high. Moreover, a monitor faces outward in the state in which the casings are invertedly stood on the tabletop, and it is possible to perform close-up photography while checking the subject with the monitor.

However, the hinge portion cannot open the two casings beyond 180°. Therefore, it is necessary for the hinge portion to have a bi-axial structure, with an opening/closing axis for opening out and closing up the two casings and a rotation axis for turning the monitor around. Thus, a mechanism of the hinge portion is likely to be complicated.

### SUMMARY OF THE INVENTION

The present invention has been devised in consideration of the circumstances described above, and an object of the present invention is to provide an opening/closing-type portable device with a camera, which portable device alters to a shape for close-up photography, raises steadiness at times of close-up photography, and avoids complication of a mechanism of a hinge portion.

In order to achieve the object described above, according to a first aspect of the present invention, a portable device with a camera is provided, the device including: (a) a first casing body including one surface, at which a control portion is provided, and an opposite surface; (b) a second casing body including one surface, at which a monitor is provided, and an opposite surface; (c) a hinge portion joining the first casing body and the second casing body such that the first casing body and the second casing body are rotatable relative to one another about the hinge; and (d) the camera, which is provided at the hinge portion, (e) the portable device can be put into a first state, in which the first casing body and the second casing body are superposed such that the one face of the first casing body and the one face of the second casing body oppose one another, and a second state, in which the first casing body and the second casing body are relatively rotated from the first state by a predetermined angle about an axis of the hinge portion such that the opposite surface of the first casing body and the opposite surface of the second casing body nearly oppose one another.

The foregoing, and other objects, features and advantages of the present invention will be apparent to one skilled in the art from the following descriptions of preferred embodiments of the present invention, as illustrated in the accompanying drawings, and the attached claims.

### BRIEF DESCRIPTION OF THE DRAWINGS

FIG. 1 is a perspective view showing a portable telephone incorporating a camera of a first embodiment of the present invention.

FIG. 2 is an exploded perspective view of a hinge portion and a camera unit of the portable telephone with camera of the first embodiment.

FIGS. 3A, 3B, 3C and 3D are sectional views showing states of an operation in which the camera unit of the portable telephone with camera of the first embodiment rotates.

FIG. 4 is an exploded perspective view showing the hinge portion of the portable telephone with camera of the first embodiment.

FIG. 5 is a sectional view showing the hinge portion of the portable telephone with camera of the first embodiment.

FIGS. 6A and 6B are sectional views showing the hinge portion of the portable telephone with camera of the first embodiment.

FIGS. 7A and 7B are sectional views showing the hinge portion of the portable telephone with camera of the first embodiment.

FIG. 8 is a perspective view showing a state of close-up photography of the portable telephone with camera of the first embodiment.

FIG. 9 is a side view showing the state of close-up photography of the portable telephone with camera of the first embodiment.

FIG. 10 is a block diagram showing structure of a circuit for controlling the camera unit of the portable telephone with camera of the first embodiment.

FIGS. 11A and 11B are sectional diagrams showing sensing means for detecting a position of rotation of a second casing body of the portable telephone with camera of the first embodiment.

FIG. 12 is a sectional side view of principal components showing a state in which a portable telephone incorporating a camera of a second embodiment is opened out.

FIG. 13 is a sectional side view of principal components showing a state in which the portable telephone with camera of the second embodiment is folded over backward.

FIG. 14 is a sectional side view of principal components of a portable telephone incorporating a camera of a third embodiment.

FIG. 15 is a sectional side view of principal components showing a state in which the portable telephone with camera of the third embodiment is folded over backward.

### DETAILED DESCRIPTION OF THE INVENTION

Below, a plurality of embodiments of a portable device incorporating a camera relating to the present invention will be described in detail with reference to the drawings.

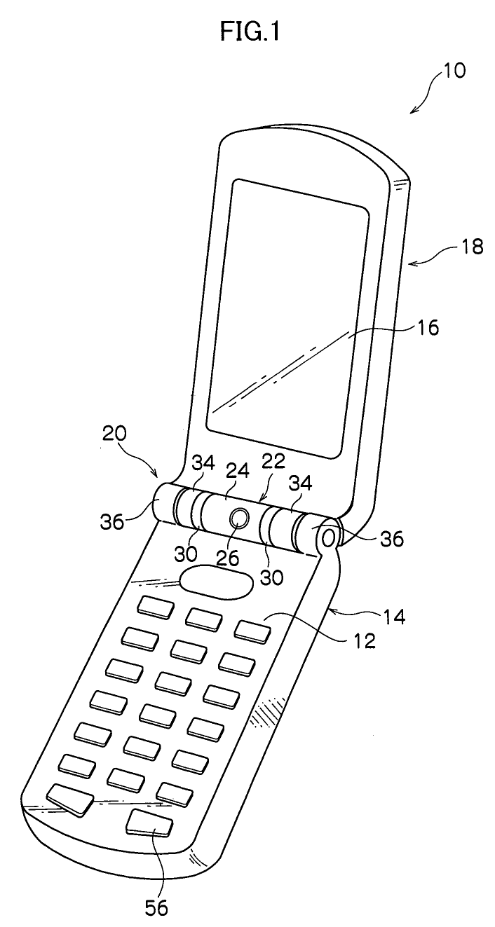

Referring to FIG. 1, at a portable telephone with a camera 10 of a first embodiment, a first casing body 14 and a second casing body 18 are openably/closeably joined by a hinge portion 20. The first casing body 14 is provided with a control portion 12, and the second casing body 18 is provided with a monitor 16. In a state in which the first casing body 14 and second casing body 18 are closed up, the monitor 16 and the control portion 12 are accommodated at inner sides of the first casing body 14 and second casing body 18, and are close to and facing one another.

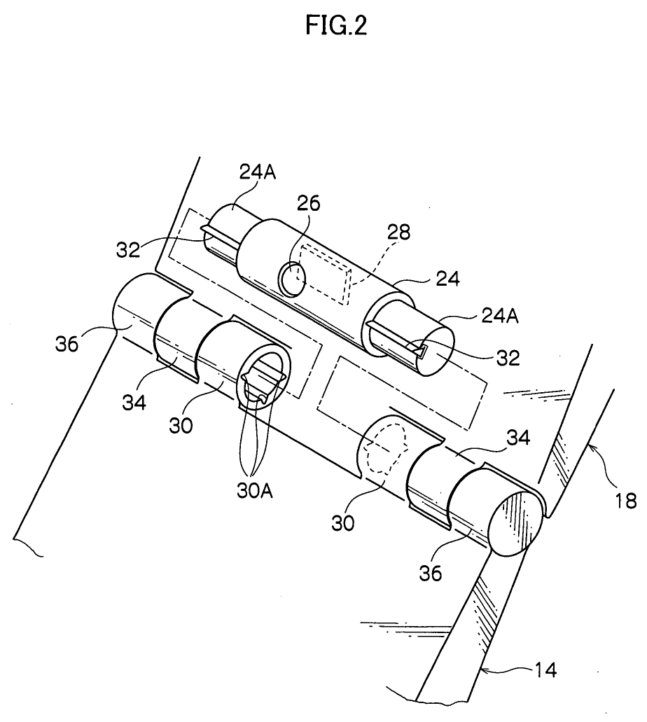

A camera unit 22 is rotatably provided at a central portion of the hinge portion 20. As shown in FIG. 2, at the camera unit 22, an imaging lens 26 is provided at a front face of a circular tube-form casing 24, and a CCD 28 is provided inside the casing 24. A central portion of an image pickup surface of the CCD 28 is aligned with an optical axis of the imaging lens 26.

Portions at two end portions of the casing 24 are formed with narrower diameters to serve as rotation shafts 24A. Bearings 30, which are formed at an end face of the first casing body 14, rotatably support these rotation shafts 24A. Latches 32 are provided at circumferential faces of the rotation shafts 24A. At the latches 32, distal end portions 32A thereof, which are folded over in triangular forms, are caused to protrude from the circumferential faces of the rotation shafts 24A by plate springs, which extend in the axial direction of the rotation shafts 24A.

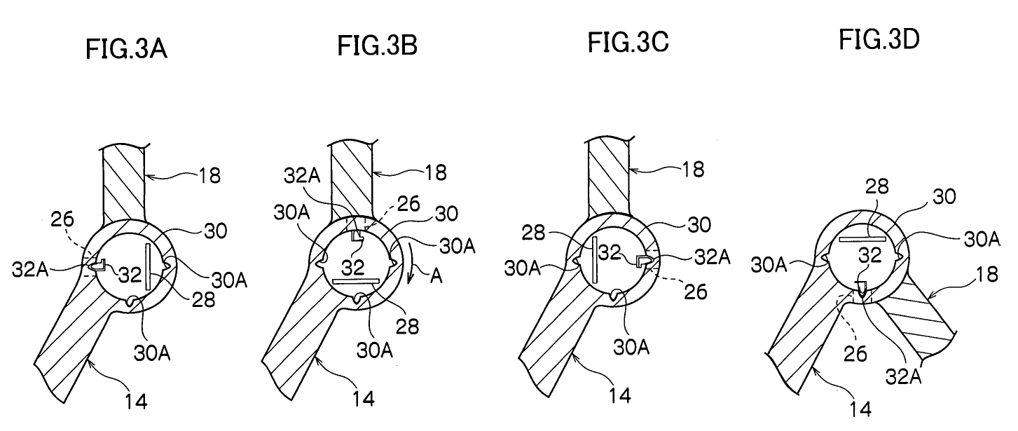

Anchoring grooves 30A, 30B and 30C, which engage with the latches 32, are formed at inner circumferential faces of the bearings 30. The anchoring grooves 30A are formed at the control portion 12 side of the first casing body 14. As is shown in FIG. 3A, when the latches 32 are engaged with the anchoring grooves 30A, the imaging lens 26 is oriented toward a user. Thus, a “self-portrait”, in which a camera user photographs him/herself, is possible.

As shown in FIG. 3B, when the camera unit 22 is rotated in a clockwise direction (the direction of arrow A in the drawing), the latches 32 are pushed into the circumferential faces of the rotation shafts 24A by the inner circumferential faces of the bearings 30.

As shown in FIG. 3C, the anchoring grooves 30B are formed at an interval of approximately 180° from the anchoring grooves 30A. When the rotation shafts 24A are rotated to the positions of these anchoring grooves 30B, the latches 32 are protruded from the circumferential faces of the rotation shafts 24A by resilient force and are engaged with the anchoring grooves 30B. In this state, the imaging lens 26 is oriented to the opposite side from the operator, that is, toward usual photographic subjects. Hence, it is possible to photograph subjects which are located in front of the camera user.

As shown in FIG. 3D, the anchoring grooves 30C are formed at intervals of approximately 90° from the anchoring grooves 30A and the anchoring grooves 30B (intermediate to the anchoring grooves 30A and 30B). When the latches 32 are engaged with these anchoring grooves 30C, the imaging lens 26 is oriented toward subjects which are the targets of close-up photography, as described later. Hence, close-up photography is possible.

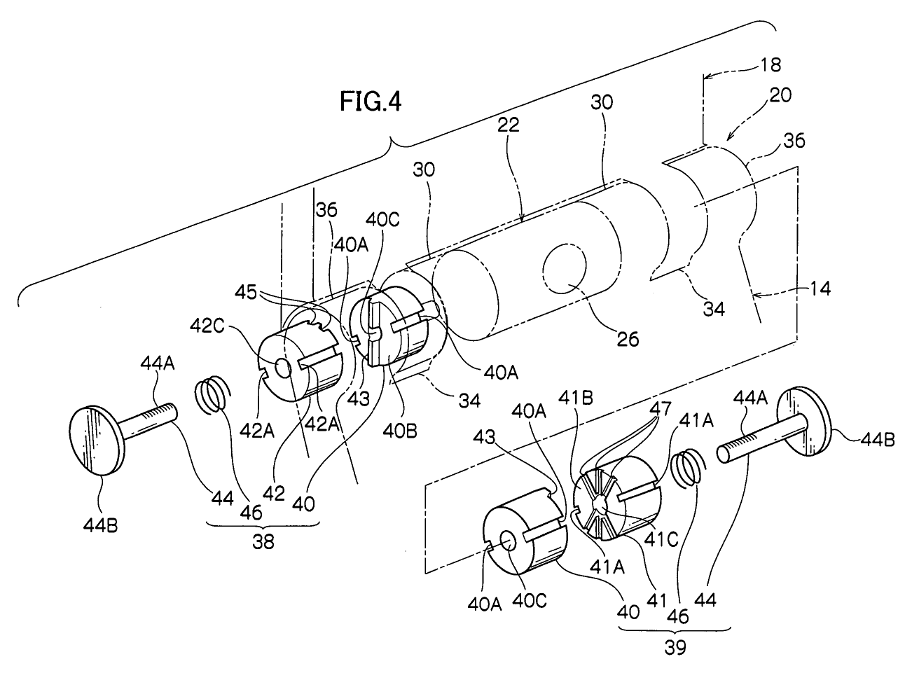

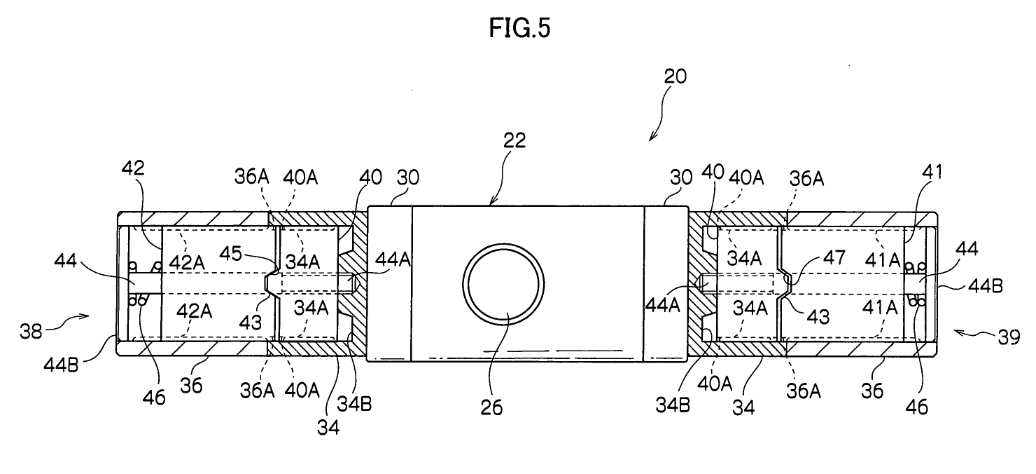

As shown in FIGS. 4 and 5, two first tubular bodies 34 are formed at an end face of the second casing body 18, and the bearings 30 are disposed between the two first tubular bodies 34. Two second tubular bodies 36 are formed at end faces of the first casing body 14, and the first tubular bodies 34 are disposed between the two second tubular bodies 36. The first tubular bodies 34 are tubular bodies with bases, with axial direction one end portions thereof (at the respective bearing 30 sides) serving as base faces 34B. The second tubular bodies 36 are tubular bodies of which both end portions in the axial direction are open.

Hinges 38 and 39 are inserted into the first tubular bodies 34 and second tubular bodies 36, enabling opening/closing of the first casing body 14 and second casing body 18. The hinge 38, which is disposed at the left side in the drawings, is structured by a first hinge 40, a second hinge 42, a rotation shaft 44 and a compression coil spring 46. The hinge 39, which is disposed at the right side in the drawings, is structured by another first hinge 40, a second hinge 41, another rotation shaft 44 and another compression coil spring 46. Note that the components assigned the same reference numerals, i.e., the first hinges 40, the rotation shafts 44 and the compression coil springs 46, are common components.

Each first hinge 40 has a circular tube form and is inserted into the first tubular body 34. Two key grooves 40A, which extend in the axial direction at a circumferential face of the first hinge 40, are formed with a spacing of 180°. Two keys 34A, which are formed at an inner circumferential face of the first tubular body 34, are formed with a spacing of 180° and engage with the key grooves 40A. Accordingly, the first hinges 40 are non-rotatable in the first tubular bodies 34.

The second hinge 42 has a circular tube form with the same diameter as the first hinge 40, and is inserted into the second tubular body 36 at the left side of the drawings. Two key grooves 42A, which extend in the axial direction at a circumferential face of the second hinge 42, are formed with a spacing of 180°. Two keys 36A, which engage with the two key grooves 42A, are formed with a spacing of 180° at an inner circumferential face of the second tubular body 36. Accordingly, the second hinge 42 is non-rotatable in the second tubular body 36.

The second hinge 41 of the hinge 39 has a circular tube form with the same diameter as the first hinge 40, and is inserted into the second tubular body 36 at the right side of the drawings. Two key grooves 41A, which extend in the axial direction at a circumferential face of the second hinge 41, are formed with a spacing of 180°, and engage with two more keys 36A, which are formed with a spacing of 180° at the inner circumferential face of the second tubular body 36. Accordingly, the second hinge 41 is non-rotatable in the right-side second tubular body 36.

At each rotation shaft 44, a screw portion 44A is formed at one axial direction end portion and a head portion 44B is formed at the other axial direction end portion. The rotation shafts 44 pass through the first hinge 40 and second hinge 42 of the hinge 38, and the first hinge 40 and second hinge 41 of the hinge 39, respectively, and the rotation shafts 44 screw into the base faces 34B of the first tubular bodies 34.

The compression coil springs 46 are disposed between the second hinge 42 and the corresponding head portion 44B and between the second hinge 41 and the corresponding head portion 44B, respectively, and urge the second hinge 41 and the second hinge 42, respectively, towards the first hinges 40.

A cam 43 and cams 45 are formed at, respectively, an abutting face 40B of the first hinge 40 and an abutting face 42B of the second hinge 42. The cam 43 is a protrusion with a taper form in cross-section, and the cams 45 are grooves with taper forms in cross-section, which engage with the cam 43.

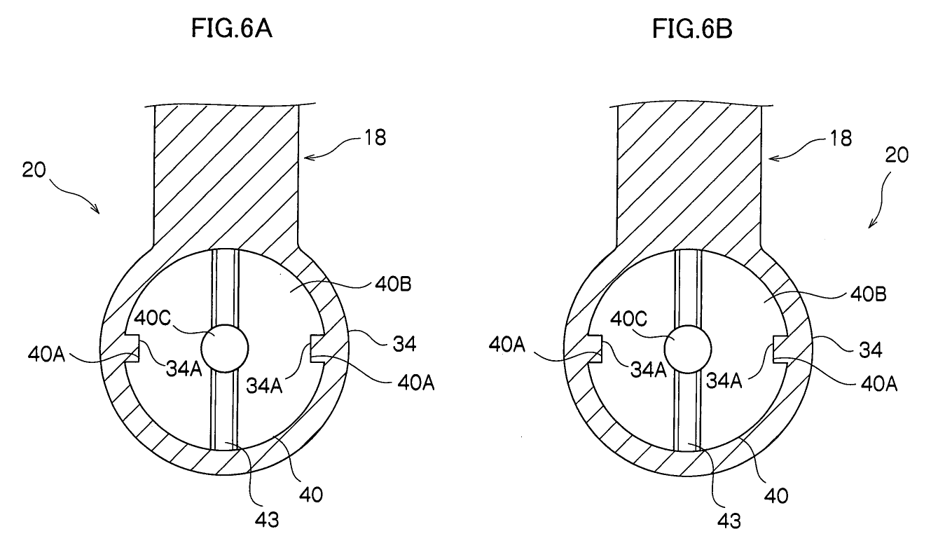

As shown in FIGS. 6A and 6B, the cam 43 extends from an end face of the abutting face 40B to an end face at an opposite side of the abutting face 40B, transiting across a hole 40C. The two keys 34A are arranged along a direction of thickness of the second casing body 18, and the cam 43 extends in a radial direction with an angle of approximately 90° to a direction of arrangement of the two key grooves 40A. That is, in the state in which the first hinge 40 is inserted into the first tubular body 34, the cam 43 extends in a direction substantially intersecting the thickness direction of the second casing body 18.

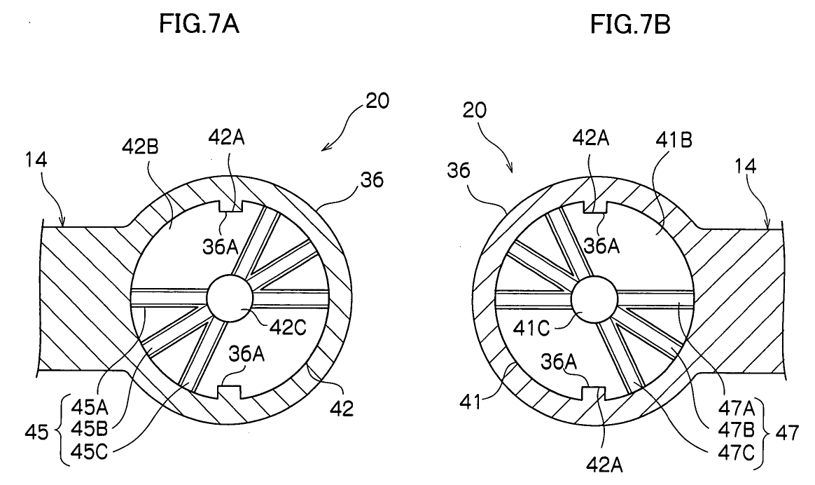

As shown in FIG. 7A, the cams 45 are structured by three cams, a first cam 45A, a second cam 45B and a third cam 45C, which extend from an end face of the abutting face 42B to an end face at an opposite side of the abutting face 42B, transiting across a hole 42C. The two keys 36A are arranged along a direction of thickness of the first casing body 14, and the first cam 45A extends in a radial direction with an angle of approximately 90° to a direction of arrangement of the two key grooves 42A. That is, in the state in which the second hinge 42 is inserted into the second tubular body 36 at the left side of FIGS. 4 and 5, the first cam 45A extends in a direction substantially intersecting the thickness direction of the first casing body 14.

The second cam 45B extends at an angle approximately 30° in an anti-clockwise direction of the drawing relative to the first cam 45A, and the third cam 45C extends at an angle approximately 30° in the anti-clockwise direction relative to the second cam 45B.

As shown in FIGS. 4 and 5, another cam 43 and cams 47 are formed at, respectively, another abutting face 40B of the first hinge 40 of the hinge 39 and an abutting face 41B of the second hinge 41. This cam 43 is as described above.

The cams 47 are grooves with taper forms in cross-section, which engage with the cam 43. As shown in FIG. 7A, the cam 47 is structured by three cams, a first cam 47A, a second cam 47B and a third cam 47C, which extend from an end face of the abutting face 41B to an end face at an opposite side of the abutting face 41B, transiting across a hole 41C. The first cam 47A extends in a radial direction with an angle of approximately 90° to a direction of arrangement of the two key grooves 41A. That is, in the state in which the second hinge 41 is inserted into the second tubular body 36 at the right side of FIGS. 4 and 5, the first cam 47A extends in a direction substantially intersecting the thickness direction of the first casing body 14.

The second cam 47B extends at an angle approximately 30° in a clockwise direction of the drawing relative to the first cam 47A, and the third cam 47C extends at an angle approximately 30° in the clockwise direction relative to the second cam 47B.

In the state in which the first casing body 14 and second casing body 18 are closed up, the cam 43 of the first hinge 40 of the hinge 38 engages with the first cam 45A of the second hinge 42, and the cam 43 of the first hinge 40 of the hinge 39 engages with the first cam 47A of the second hinge 41. In this state, the second hinges 41 and 42 are urged against the first hinges 40 by the compression coil springs 46, the hinges 38 and 39 are locked, and there is no looseness between the first casing body 14 and the second casing body 18.

When the second casing body 18 is opened out from the closed state, an angled surface of the first cam 45A of the hinge 38 pushes against an angled surface of the corresponding cam 43, and an angled surface of the first cam 47A of the hinge 39 pushes against an angled surface of the corresponding cam 43. As a result, engagements of the first cam 45A with the cam 43 of the hinge 38 and of the first cam 47A with the cam 43 of the hinge 39 are released, and the hinge 38 and hinge 39 become rotatable.

When the second casing body 18 has opened to 120° from the closed state, the cam 43 of the first hinge 40 of the hinge 38 engages with the third cam 45C of the second hinge 42, and the cam 43 of the first hinge 40 of the hinge 39 engages with the third cam 47C of the second hinge 41.

When the second casing body 18 opens a further 30° and reaches a state of having been opened to 150° (another rotation position), the cam 43 of the first hinge 40 of the hinge 38 engages with the second cam 45B of the second hinge 42, and the cam 43 of the first hinge 40 of the hinge 39 engages with the second cam 47B of the second hinge 41. In the state in which the second casing body 18 has been opened to 150° (another rotation position) as shown in FIG. 1, or a state in which the second casing body 18 has opened a further 30° to 180° (another rotation position), the portable telephone with camera 10 is in a condition for performing telephone calls, usual photography and the like. In this state, the first casing body 14 and the second casing body 18 are locked by the hinges 38 and 39. Thus, telephone calls, usual photography, etc. can be performed without difficulty.

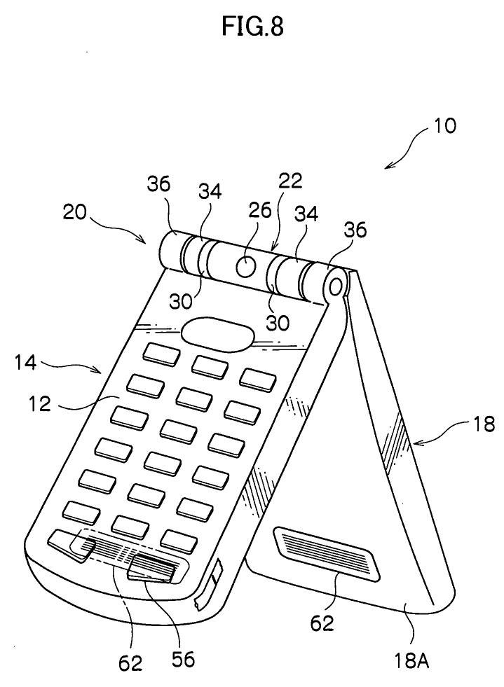

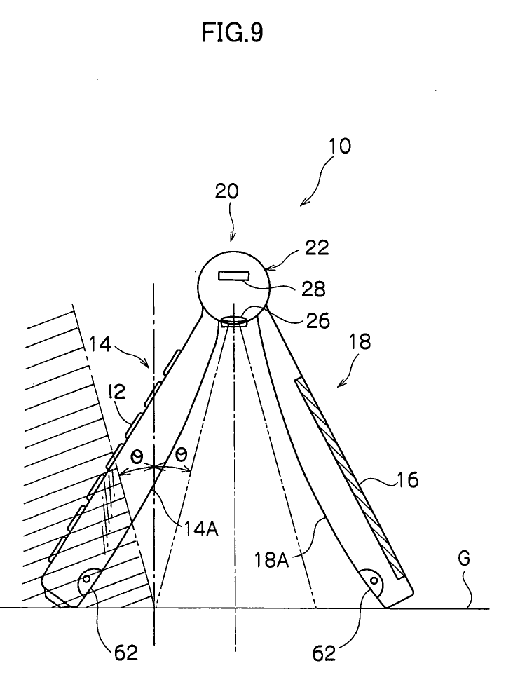

When the second casing body 18 is opened to 300° (a first rotation position), the cam 43 of the first hinge 40 of the hinge 38 engages with the third cam 45C of the second hinge 42, and the cam 43 of the first hinge 40 of the hinge 39 engages with the third cam 47C of the second hinge 41. As a result, as shown in FIGS. 8 and 9, the first casing body 14 and the second casing body 18 are locked in a state which is opened by 300° from the closed state. Hence, the first casing body 14 and second casing body 18 can be invertedly stood on a flat surface G with the hinge portion 20 oriented upward.

In this state, the control portion 12 and the monitor 16 face to outer sides. Further, the camera unit 22 is locked centrally to inner sides of the first casing body 14 and the second casing body 18, as described earlier. Consequently, it is possible to operate the control portion 12 and photograph a subject on the flat surface G while checking the subject with the monitor 16.

Thus, because a degree of freedom of rotation of the hinge portion 20 is raised, a rotation axis for turning the monitor 16 around is not necessary, and it is possible for the hinge portion 20 to have a uni-axial form. Consequently, complication of the structure of the hinge portion 20 can be avoided.

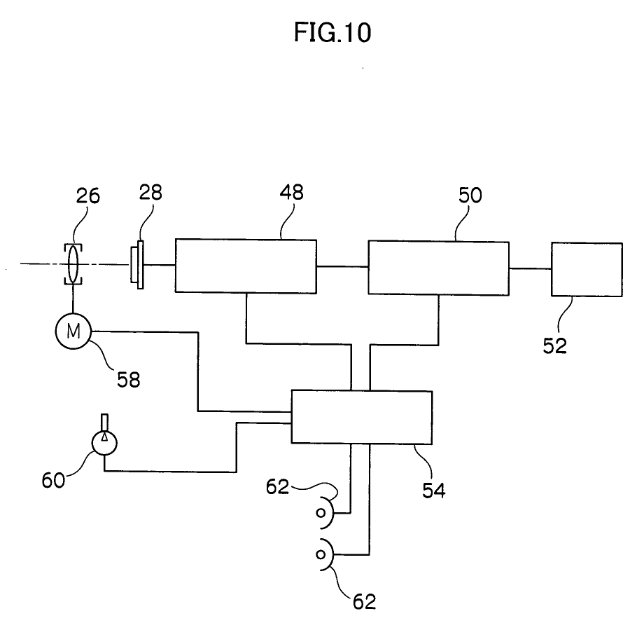

FIG. 10 shows a block diagram representing structure of a circuit for controlling the camera unit 22 of the portable telephone with camera 10 of the present embodiment.

The portable telephone with camera 10 is equipped with the imaging lens 26, the CCD 28, image signal processing means 48, a memory controller 50 and memory 52. A subject which is focused through the imaging lens 26 onto the CCD 28 is converted to analog image signals by the CCD 28. Then, the analog image signals, which are outputted from the CCD 28, are subjected to analog signal processing, A/D conversion and digital signal processing by the image signal processing means 48. The digital image data that has been subjected to the digital signal processing is compressed by the memory controller 50 and recorded at the memory 52. Depending on a photography mode, the compression process may be omitted and the data recorded directly to the memory 52. Hence, the digital image data stored at the memory 52 is read out to the monitor 16, and an image of the subject is displayed at the monitor 16.

The portable telephone with camera 10 is equipped with a system controller 54 which oversees control of the portable telephone with camera 10 as a whole. Taking of a photograph is implemented by operating the control portion 12 to set desired photography conditions and pressing a shutter button 56 (see FIGS. 1 and 8).

A zoom motor 58, sensing means 60 and lights 62 are provided at the portable telephone with camera 10. The zoom motor 58 drives the imaging lens 26 for zooming, and the sensing means 60 detects when the second casing body 18 has been opened to 300° (the first rotation position).

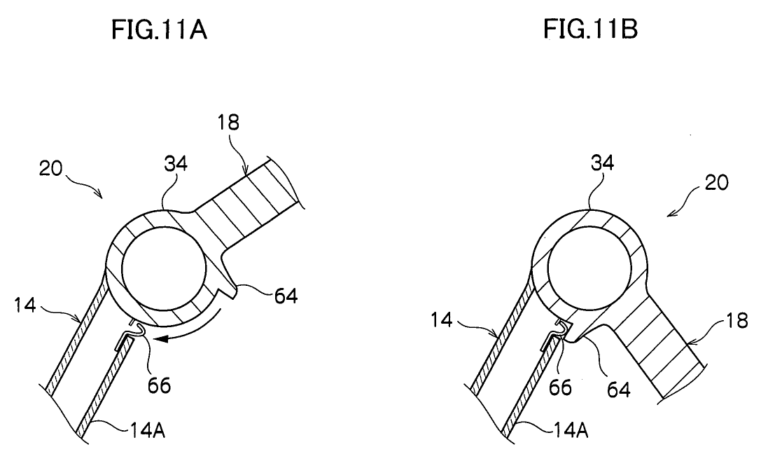

As shown in FIGS. 11A and 11B, the sensing means 60 is structured by a detection protrusion 64 and a detection contact 66. The detection protrusion 64 is formed at an outer peripheral surface of the first tubular body 34 of the second casing body 18, and the detection contact 66 is provided at a rear face 14A of the first casing body 14 and conducts electricity when pressed by the detection protrusion 64.

When the second casing body 18 is rotated as shown in FIG. 11A to the first rotation position, the detection protrusion 64 pushes against the detection contact 66, as shown in FIG. 11B, and the detection contact 66, which has been open hitherto, is closed. Hence, a detection signal that the detection contact 66 has closed is sent to the system controller 54. When the system controller 54 receives the detection signal, the system controller 54 drives the zoom motor 58, alters a searching range of the imaging lens 26 to a macro region, and switches the photography mode to a macro (close-up) photography mode. Further, the lights 62, which are provided at the rear face 14A of the first casing body 14 and a rear face 18A of the second casing body 18, are lit up.

In consequence, close-up photography of a subject which is located between the first casing body 14 and the second casing body 18 on the flat surface G on which the first casing body 14 and second casing body 18 are invertedly standing is possible. Moreover, because the first casing body 14 and second casing body 18 are inverted on the flat surface G with the hinge portion 20 oriented upward for performing close-up photography, a distance between subjects and the camera is constant, and it is possible to perform stable close-up photography. Furthermore, because of the illumination of the lights 62, bright close-up images can be obtained.

The first casing body 14 and the second casing body 18 are equipped at their respective tips with the lights 62 such that, when the first casing body 14 and the second casing body 18 are inverted on the flat surface G with the hinge portion 20 oriented upward, the lights 62 are located within a hatched (or shaded) area as shown in FIG. 9.

In a case in which a light is located within such a hatched area, alight beam, which has been discharged from the light and subsequently reflected from the surface G, does not enter the CCD 28. Namely, the possibility of reflectance (or flashing) of the light beam (on a photograph, a display or the like) can be prevented.

Next, a second embodiment of the present invention will be described. Note that portions and components that are the same as in the first embodiment are assigned the same reference numerals, and descriptions thereof are omitted as appropriate.

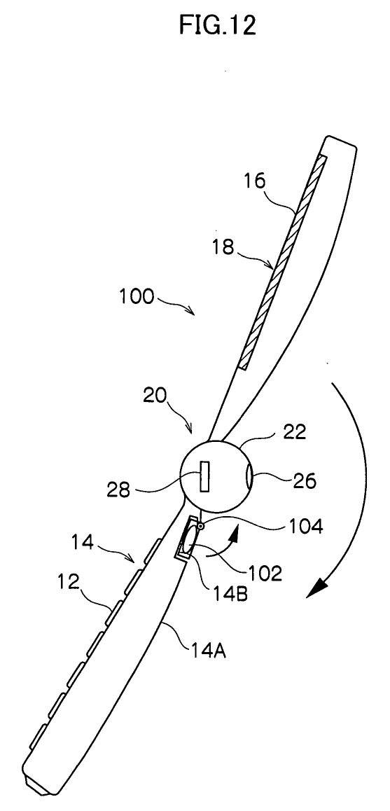

As shown in FIG. 12, a portable telephone with a camera 100 is provided with a close-up photography lens 102 at the rear face 14A, which is a face of the first casing body 14 opposite to a face of the first casing body 14 at which the control portion 12 is provided. This close-up photography lens 102 can be moved, by a hinge 104, into and out of an accommodation portion 14B of the rear face 14A of the first casing body 14.

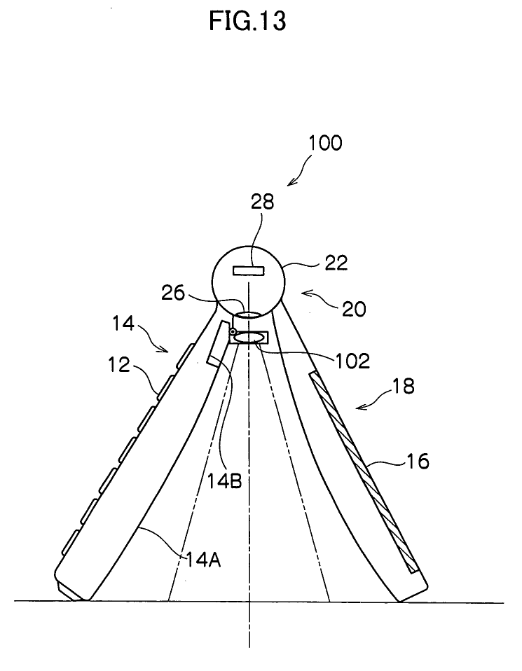

As shown in FIG. 13, the second casing body 18 is rotated to the first rotation position and the camera unit 22 is rotated to the center at the inner sides of the first casing body 14 and the second casing body 18. Further, the close-up photography lens 102 folds out from the accommodation portion 14B and is disposed at a front face side of the imaging lens 26 of the camera unit 22. In consequence, a subject disposed on the flat surface G at the inner sides of the first casing body 14 and second casing body 18 will be in focus, and close-up photography is possible.

Next, a third embodiment of the present invention will be described. Note that portions and components that are the same as in the first or second embodiment are assigned the same reference numerals, and descriptions thereof are omitted as appropriate.

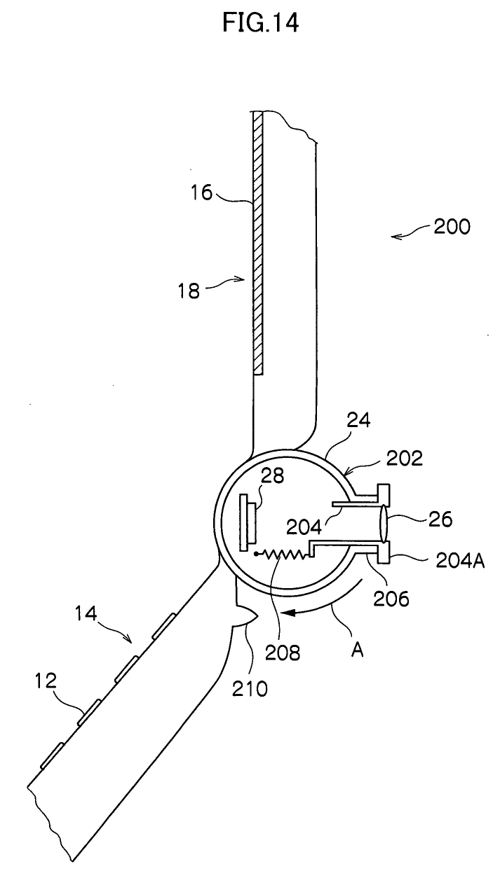

As shown in FIG. 14, at a portable telephone with a camera 200, the imaging lens 26 of a camera unit 202 is accommodated in a lens barrel 204. A cylindrical body 206 is formed integrally with the casing 24. The lens barrel 204 is supported by the cylindrical body 206 to be movable in an optical axis direction of the imaging lens 26. An end portion of the lens barrel 204 at the CCD 28 side thereof in the optical axis direction is supported by an extension coil spring 208.

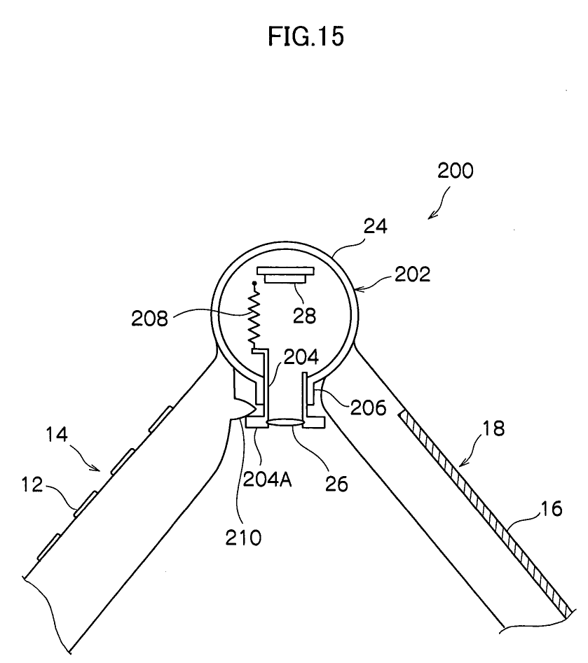

The camera unit 202 is formed to be rotatable by a structure similar to that of the first and second embodiments. A cam 210 is formed at the rear face 14A of the first casing body 14, and a brim portion 204A is formed at a distal end portion of the lens barrel 204. When the camera unit 202 is rotated in a direction such that the imaging lens 26 approaches the first casing body 14 (the direction of arrow A in the drawing), the cam 210 abuts against the brim portion 204A, as shown in FIG. 15. As a result, the lens barrel 204 is pushed outward and the imaging lens 26 is moved to a close-up position at which a subject on the flat surface G will be in focus.

In the first to third embodiments, the camera unit 22 (or 202) is formed to be rotatable by turning at the hinge portion 20. However, the camera unit 22 (or 202) may be fixed at the hinge portion 20 such that, when the second casing body 18 is opened approximately 300° from the closed state as shown in FIG. 9, the imaging lens 26 faces a subject at the inner sides of the first casing body 14 and the second casing body 18. Alternatively, the camera unit 22 (or 202) may rotate in conjunction with rotation of the second casing body 18 such that, when the second casing body 18 is opened approximately 300° from the closed state, the imaging lens 26 is rotated to a position that faces a subject at the inner sides of the first casing body 14 and the second casing body 18.

Further, although the angles at which the second casing body 18 is locked by the hinge portion 20 in the first to third embodiments are 120°, 150°, 180° and 300°, such angles can be selected as is appropriate.

Further again, in the first to third embodiments, the CCD 28 is disposed at the hinge portion 20. However, a reflection mirror may be disposed at the position at which the CCD 28 is disposed in the above embodiments, with the CCD 28 being disposed at the first casing body 14 or the second casing body 18. The reflection mirror deflects the path of light that has passed through the imaging lens 26 to make the light incident on the CCD 28.

Further yet, in the first to third embodiments, the present invention has been described taking a portable telephone incorporating a camera as an example. However, the present invention is also applicable to other opening/closing-type (folding-type) portable devices incorporating cameras in which the cameras are provided at hinge portions, such as, for example, notebook computers, PDAs (personal digital assistants) and so forth.

With the structures described above, the present invention is capable, in an opening/closing-type portable device incorporating a camera, which portable device alters to a shape for performing close-up photography, of raising stability at times of close-up photography, while avoiding complication of structure of a hinge portion.

1. A portable device with a camera, the device comprising:
(a) a first casing body including one surface, at which a control portion is provided, and an opposite surface;
(b) a second casing body including one surface, at which a monitor is provided, and an opposite surface;
(c) a hinge portion joining the first casing body and the second casing body such that the first casing body and the second casing body are rotatable relative to one another about the hinge; and
(d) the camera, which is provided at the hinge portion,
(e) the portable device can be put into a first state, in which the first casing body and the second casing body are superposed such that the one face of the first casing body and the one face of the second casing body oppose one another, and a second state, in which the first casing body and the second casing body are relatively rotated from the first state by a predetermined angle about an axis of the hinge portion such that the opposite surface of the first casing body and the opposite surface of the second casing body nearly oppose one another.

2. The portable device of claim 1, wherein the camera is rotatable about the axis of the hinge portion.

3. The portable device of claim 1, wherein the predetermined angle is at least 180°.

4. The portable device of claim 1, wherein the hinge portion is capable of temporarily fixing the first casing body and the second casing body relative to one another in the second state.

5. The portable device of claim 1 wherein, in the second state, the camera is capable of capturing a subject disposed between the opposite surfaces of the first casing body and the second casing body.

6. The portable device of claim 1, further comprising a detection portion capable of detecting when the first casing body and the second casing body are in the second state.

7. The portable device of claim 6, further comprising a control section which, in response to a detection signal from the detection portion, switches a photography mode of the camera to a close-up photography mode.

8. The portable device of claim 7, wherein the camera comprises an imaging lens.

9. The portable device of claim 8, wherein the control section comprises a zoom motor for altering a searching range of the imaging lens to a macro region.

10. The portable device of claim 8, wherein the camera comprises a close-up photography lens which can be disposed at a front face side of the imaging lens.

11. The portable device of claim 10, wherein the close-up photography lens is provided in a protruding condition and can be accommodated at the opposite surface of one of the casing bodies.

12. The portable device of claim 8, further comprising a movement apparatus capable of moving the imaging lens to a predetermined close-up photography position.

13. The portable device of claim 1, wherein the hinge portion is capable of temporarily fixing the first casing body and the second casing body at a plurality of angular positions relative to one another.

14. The portable device of claim 1, wherein the camera comprises a CCD.

15. The portable device of claim 14, wherein the CCD is disposed inside one of the first casing body and the second casing body.
